(19) United States
(12) Patent Application Publication
(10) Pub. No.: US 2016/0143218 A1
(43) Pub. Date: May 26, 2016

(54) LINE FEED MECHANISM FOR STRING TRIMMER

(71) Applicant: BLACK & DECKER INC., Newark, DE (US)

(72) Inventors: Oleksiy P. SERGYEYENKO, Baldwin, MD (US); Brian POOLE, Lutherville, MD (US)

(21) Appl. No.: 14/552,682

(22) Filed: Nov. 25, 2014

(51) Int. Cl. A01D 34/416

(52) U.S. Cl. CPC A01D 34/4162

(57) ABSTRACT

A string trimmer with a controller that brakes an electric motor so that the electric motor can selectively generate a moment that is used as a control signal for a line pay-out mechanism.

### FIELD

The present disclosure relates to a string trimmer having a line pay-out mechanism.

### BACKGROUND

This section provides background information related to the present disclosure which is not necessarily prior art.

String trimmers having “auto-feed” line pay-out mechanism are known in the art as is known from references such as EP 0 417 966, EP 0 417 967, U.S. Pat. No. 6,594,907, U.S. Pat. No. 5,603,673 and U.S. Pat. No. 4,607,431. In brief, such auto-feed line pay-out mechanisms typically employ a reference weight that is counteracted by an inertial force associated with one or more line segments of the trimmer line that extend from a spool assembly. In situations where the moment that results from the inertial force that is associated with the line segment(s) is greater than an opposing moment that results from an inertial force that is associated with the reference weight, the auto-feed mechanism inhibits relative rotation of a spool so that trimming line is not paid-out from the spool. In situations where the moment that results from the inertial force that is associated with the line segment(s) is less than the opposing moment that results from the inertial force that is associated with the reference weight, the auto-feed mechanism permits relative rotation of the spool so that trimming line is paid-out from the spool.

While such mechanisms are suited for their intended purpose, there are several disadvantages. One disadvantage concerns the need for ensuring that the reference weight is properly designed and manufactured. As those of ordinary skill in the art will appreciate, errors in the manufacture of the reference weight can adversely affect the manner in which the auto-feed line pay-out mechanism will operate, feeding out too much, too little or no line at all. Additionally, because of the delicate nature of the balancing, minor impacts on the lines create force imbalances and inadvertently feed additional line.

Additional mechanisms for feeding line are described in U.S. Pat. No. 4,426,780 or U.S. Pat. No. 4,245,454, the disclosures of which are hereby incorporated by reference as if fully set forth in detail herein. The US '780 patent describes a string trimmer that is configured to pay out line from a spool in response to deceleration of a driving portion relative to a spool when the electric motor of the string trimmer is turned off. The US '454 patent describes a string trimmer that is configured to pay out line from a spool in response to the operation of a mechanical brake mechanism that slows rotation of a motor shaft and a spool relative to a guide drum. However, these design are overly complex.

Accordingly, there remains a need in the art for a spool assembly with a line pay-out mechanism that does not require a reference weight with a relatively tight weight tolerance and will feed out line only when intended. Those of skill in the art will appreciate that the motor braking/reversal technique disclosed herein can be effective with such line-feed mechanisms to cause trimmer line to be paid-out from a spool.

### SUMMARY

This section provides a general summary of the disclosure, and is not a comprehensive disclosure of its full scope or all of its features.

In one form, the present teachings provide a string trimmer that includes an electric motor, a rotatable output member driven by the electric motor, a handle coupled to the electric motor, a spool assembly and a controller. The spool assembly is configured to hold a trimming line such that the trimming line has one or more line segments that extend from the spool assembly. The spool assembly has a spool housing, a spool and a line pay-out mechanism. The spool is coupled to the output member and is configured such that the trimming line is wound thereon. The line pay-out mechanism is configured to control rotation of the spool relative to the output member to pay-out the trimming line from the spool in response to a difference between a first moment and a second moment. The first moment is generated by inertia of the one or more line segments. The second moment is generated by inertia of a reference weight and opposes the first moment. The controller is coupled to the electric motor and is configured to selectively control the electric motor select a line pay-out mode that generates a third moment that opposes the first moment. The line pay-out mechanism is operable in a pay-out mode to permit the spool to rotate relative to the output member to pay-out trimming line when a sum of the second and third moments is greater than the first moment.

In another form, the present disclosure provide a method for operating a string trimmer. The method includes providing a string trimmer with an electric motor, an output member driven by the electric motor and a spool assembly, the spool assembly having a spool housing, a spool and a line pay-out mechanism, the spool having a cavity onto which a trimmer line is wound, the line pay-out mechanism being operable in a pay-out mode to permit the spool to rotate relative to the output member to pay-out trimmer line from the spool; operating the electric motor in a trimming mode in which the electric motor operates in a first rotational direction to drive the output member, wherein inertial forces acting on the line pay-out mechanism prevent relative movement of the spool relative to the output member so that the trimming line is not paid-out from the spool assembly; and operating the electric motor in a line pay-out mode to generate a line pay-out moment that opposes a line moment that is generated by inertial forces associated with one or more segments of the trimmer line that extend from the spool assembly; wherein the line pay-out mechanism operates to pay-out trimmer line from the spool assembly when a sum of moments acting on the spool assembly is non-zero and acts in the rotational direction of the line pay-out moment.

In yet another form, the present disclosure provides a string trimmer that includes an electric motor, an output member, a handle, a switch, and a spool assembly. The electric motor has a motor shaft and is operable in a trimming mode and a line pay-out mode. The motor shaft is driven in a first rotational direction when the electric motor is operated in the trimming mode. The electric motor produces a line pay-out moment that is directed in a second rotational direction opposite the first rotational direction when the electric motor is operated in the line pay-out mode. The output member is driven by the motor shaft. The handle is coupled to the electric motor. The switch is coupled to the electric motor and is configured to selectively operate the electric motor in the line pay-out mode. The spool assembly is configured to hold a trimming line such that the trimming line has one or more line segments that extend from the spool assembly. The spool assembly has a spool housing, a spool and a line pay-out mechanism. The spool is coupled to the output member and configured such that the trimming line is wound thereon. The line pay-out mechanism is configured to control rotation of the spool relative to the output member to pay-out the trimming line from the spool. Inertial forces acting on the line pay-out mechanism when the electric motor is operated in the trimming mode prevent rotation of the spool relative to the output member so that the trimming line is not paid-out from the spool assembly. The line pay-out mechanism is operable in a pay-out mode to permit the spool to rotate relative to the output member to pay-out trimming line when a sum of moments acting on the spool assembly is non-zero and acts in the rotational direction of the line pay-out moment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary string trimmer constructed in accordance with the teachings of the present disclosure;

FIG. 2 is a side elevation view in partial section of a portion of the string trimmer of FIG. 1 that illustrates a powerhead of the string trimmer in more detail;

FIG. 3 is a perspective view of a portion of the string trimmer of FIG. 1 that illustrates a handle of the string trimmer in more detail;

FIG. 4 is a top plan view of a portion of the string trimmer of FIG. 1 that illustrates a portion of a line pay-out mechanism that is incorporated into a cap member of a spool assembly;

FIG. 5 is a bottom plan view of a portion of the string trimmer of FIG. 1 that illustrates another portion of the line pay-out mechanism that is incorporated into a spool of the spool assembly;

FIG. 6A is a schematic view of a controller in a first embodiment showing an electric motor in normal mode;

FIG. 6B is a schematic view of the controller of FIG. 6A, showing the motor in a line pay-out mode; and

FIG. 7 is a schematic view of another controller constructed in accordance with the teachings of the present disclosure.

Corresponding reference numerals indicate corresponding parts throughout the several views of the drawings.

### DETAILED DESCRIPTION

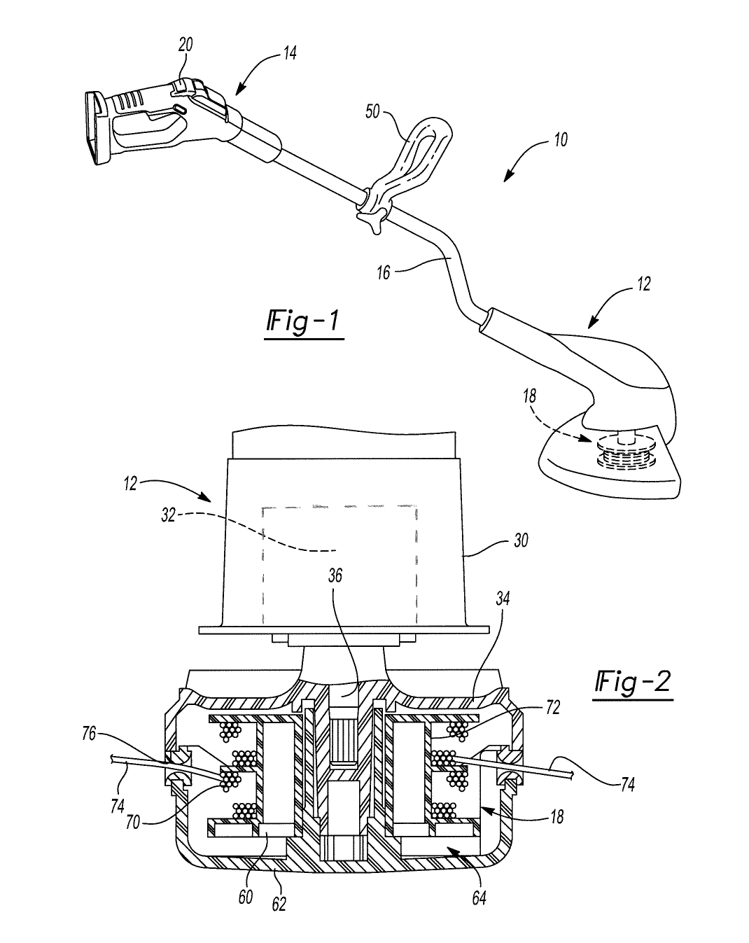

With reference to FIG. 1 of the drawings, a string trimmer constructed in accordance with the teachings of the present disclosure is generally indicated by reference numeral 10. The string trimmer 10 can be constructed in a manner that is disclosed in any of EP 0 417 966, EP 0 417 967, U.S. Pat. No. 6,594,907, U.S. Pat. No. 5,603,673 and U.S. Pat. No. 4,607,431, the disclosures of which are hereby incorporated by reference as if fully set forth in detail herein. Briefly, the string trimmer 10 can include a powerhead 12, a handle 14, a pole member 16, a spool assembly 18 and a controller 20.

With reference to FIG. 2, the powerhead 12 can include a powerhead housing 30 and an electric motor 32 with an output member 36. The powerhead housing 30 can define a cavity into which the electric motor 32 can be received. The electric motor 32 can be any type of electric motor, such as a DC electric motor or an AC electric motor. In the particular example provided, the electric motor 32 is a DC electric motor.

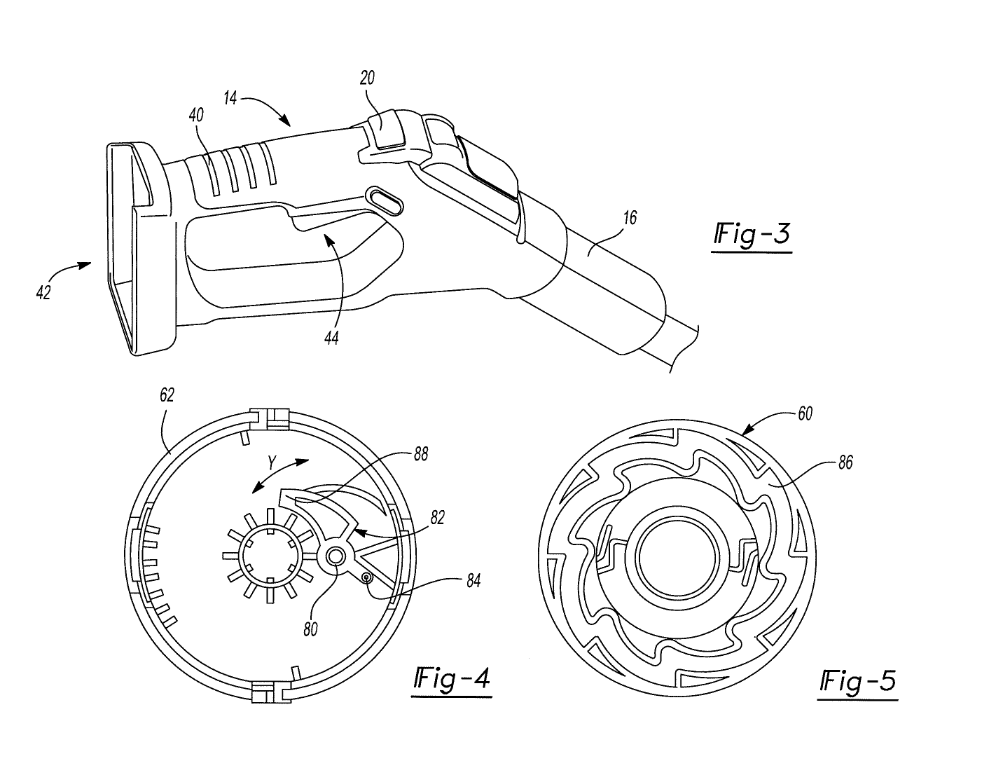

In FIGS. 1 and 3, the handle 14 can be configured with a handle member 40, a power inlet 42 and a trigger switch 44. The handle 14 is conveniently configured to be gripped by a user of the string trimmer 10. The power inlet 42 is configured to receive electrical power from an appropriate power source. In the particular example provided, the power inlet 42 is configured to mechanically and electrically engage with a battery pack (not shown) that provides a source of DC electrical power. The trigger switch 44 can be electrically coupled to the power inlet 42 and the electric motor 32 and configured to control the supply of electrical power to the electric motor 32. The trigger switch 44 can comprise a variable speed switch that is responsive to the positioning of a trigger element relative to the handle 14.

The pole member 16 can interconnect the handle 14 and the powerhead 12. In the example provided, the pole member 16 is a discrete structure that is formed of a tubular metal and configured to house wiring that runs between the handle 14 and the powerhead 12. It will be appreciated, however, that the pole member 16 could be unitarily formed with the handle 14 and/or the powerhead housing 30.

With reference to FIG. 2, the spool assembly 18 can comprise a spool housing 34, spool 60, a cap member 62 and a line pay-out mechanism 64. The spool housing 34 is fixedly secured to the output member 36 of the motor 32 for rotation therewith. The spool 60 is coupled to the spool housing 34 and configured to hold a trimming line 70, which can be wound about a line holding portion 72 of the spool 60. The trimming line 70 can have one or more line segments 74 that extend from the spool assembly 18. In the example provided, grommets 76 are provided in the spool housing 34 and receive the line segments 74. The cap member 62 has resilient legs that engage an edge of the spool housing 34 to permit the cap member 62 to be snap-fit to the spool housing 34 and the cap member 62 and the spool housing 34 cooperate to define a cavity into which the spool 60 is received.

With reference to FIGS. 2, 4 and 5, the line pay-out mechanism 64 can be configured to control rotation of the spool 60 relative to the spool housing 34 (and output member 36) and consequently, control the pay-out of trimming line 70 from the spool 60. In the particular example provided, the line pay-out mechanism 64 is similar to the mechanism described in U.S. Pat. No. 6,594,907 and includes a pin 80, a pivot arm 82 (which includes both a control peg 84 and a weight section 88) and a control groove 86. The pivot arm 82 is pivotally mounted to the pin 80, which is fixedly mounted to a first structure, such as the cap member 62. The control peg 84 is received into the control groove 86, which is formed on an end face of the spool 60. It should be understood that the pivot arm 82 and the control groove 86 could be placed in different locations so long as their relationship is maintained and the pay-out mechanism would still operate as described herein. For example, the pivot arm 82 could be positioned on the spool housing 34 and the orientation of the spool 60 flipped.

The line pay-out mechanism 64 is configured to pay-out trimming line 70 in response to a difference between first and second moments that result from inertia generated by the line segments 74 and the reference weight section 88 of the pivot arm 82. As those of skill in the art will appreciate from the above-referenced prior art, the first moment is generated by the inertial forces associated with the line segments 74, and the second moment is generated by the inertial force of the reference weight 88. In normal operation, the first moment is large enough to secure the control peg 84 within the control groove 86 so that the pivot arm 82 is maintained in a stationary position and the control peg 84 is maintained in engagement with a tooth form in the control groove 86. As the line segments 74 shorten (due to wear or breakage) during the use of the string trimmer 10 so that the inertial force produced by the line segments 74 (and the corresponding first moment) are correspondingly reduced. When the second moment, which opposes the first moment, exceeds a set reference point, the pivot arm 82 will rotate about the pin 80 and the line pay-out mechanism 64 can operate in a pay-out mode to pay-out the trimming line 70. More specifically, when the second moment exceeds the forces acting on the control peg 84 by the control groove 86 to resist in movement (including the first moment, any frictional forces between the control peg 84 and the control groove 86), the pivot arm 82 can pivot about the pin 80, causing the control peg 84 to disengage the tooth form in the control groove 86 so that the spool 60 can rotate a predetermined amount relative to the output member (and thereby pay-out the trimming line 70). In the particular example provided, the reference weight is sized such that the second moment alone is never sufficient to cause the line pay-out mechanism 64 to operate in the pay-out mode.

With reference to FIGS. 3, 6A, 6B and 7, the trigger 44 must be actuated to energize the motor 32 for the line pay-out mechanism to operate. The controller 20 can be coupled to the electric motor 32 and can be configured to selectively control the electric motor 32 in a line pay-out mode that electrically brakes or reverses the electric motor 32 and cause the line pay-out mechanism 64 to operate in a pay-out mode that permits the spool 60 to rotate relative to the output member 34 to pay-out trimming line 70. When operated in the line pay-out mode, the electric motor 32 can generate a third moment that can oppose the first moment. It will be appreciated that the line pay-out mechanism 64 can be operated in the pay-out mode when the sum of the second and third moments exceeds the first moment.

The controller 20 can be any type of mechanism that can control the operation of the electric motor. In the particular example provided in FIG. 7, the controller 20 comprises a switch that is configured to “short” the DC electric motor 32 and brake its rotation. The switch is shown in a first, normal position by the solid line, and in a second, “shorting” position shown by the dashed line. The switch can be any type of switch, but we have found that as the third moment need not be maintained for a significant period of time, a momentary switch is well suited for the task. This braking provides the third moment that initiates the line pay-out mode.

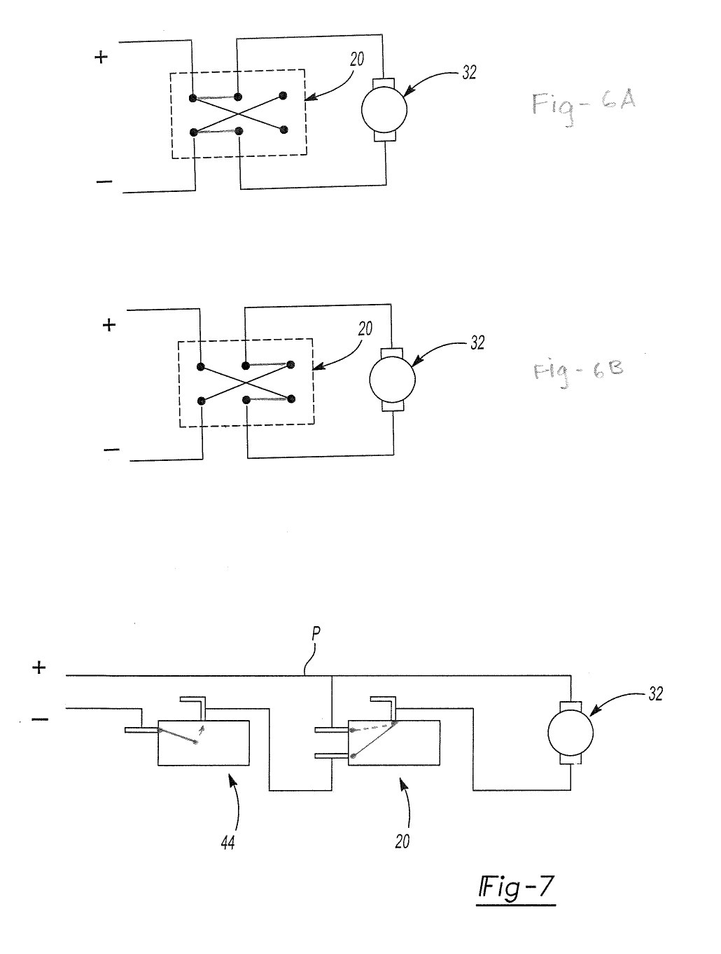

In the another example shown in FIGS. 6A and 6B, the controller 20 is part of a double pole, double throw (DPDT) switch that can be operated in a first (normal) switch mode (FIG. 6A), which supplies DC electrical current to the electric motor 32 in a first direction, and a second (line-payout) switch mode (FIG. 6B) that supplies electrical current to the electric motor 32 in a second direction, opposite direction. In the second mode, the kinetic energy of the motor 32 continues to drive it in the first direction, but the power being supplied urges the motor 32 in the second direction which effectuates a braking effect.

Therefore, by braking the motor, a strong third moment is created which overcomes the first moment to actuate the line pay-out mechanism. This strong third moment eliminates the delicate balancing required with the pivot arm 82 and furthermore, allows the pivot arm to be calibrated so that small bumps and other or other impacts on the line do inadvertently initiate the line pay-out mechanism.

Additionally, those skilled in the art will appreciate that an AC motor supplied by AC power can be braked in a similar fashion as the DC motor described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A string trimmer comprising:
an electric motor;
a rotatable output member driven by the electric motor;
a handle coupled to the electric motor;
a spool assembly that is adapted to hold a trimming line such that the trimming line has one or more line segments that extend from the spool assembly, the spool assembly having a spool housing, a spool and a line pay-out mechanism, the spool being driven by the output member and configured such that the trimming line is wound thereon, the line pay-out mechanism being configured to control rotation of the spool relative to the output member; and
a controller coupled to the electric motor and configured to selectively brake the electric motor, wherein electrical braking of the motor causes the line pay-out mechanism to operate in a pay-out mode to permit the spool to rotate relative to the output member to pay-out trimming line.

2. The string trimmer of claim 1, wherein the electric motor is housed in a powerhead assembly.

3. The string trimmer of claim 1, wherein the handle includes a trigger to control power to the motor to operate the motor in a normal mode where no line is paid out, and the controller comprises a switch to brake the motor and actuate the line pay-out mechanism.

4. The string trimmer of claim 3, wherein the controller is positioned on the handle in close proximity to the trigger so that a user can control both the trigger and controller with one hand.

5. The string trimmer of claim 3, wherein the switch is a momentary switch.

6. The string trimmer of claim 1, wherein the electric motor is a DC electric motor.

7. The string trimmer of claim 3, wherein the line pay-out mechanism includes a pivot arm with a weighted section and a control peg, and a corresponding control groove, the control peg positioned in the control groove to control rotation of the spool relative to the output member;
wherein a first moment is generated by the inertial forces associated with the trimming line, a second moment is generated by the inertial force of the weighted section, and a third moment generated by the braking of the motor;
wherein the second moment alone is never sufficient to actuate the line pay-out mechanism; and
wherein the third moment combines with the second moment to actuate the line pay-out mechanism.

8. The string trimmer of claim 7, wherein the pivot arm is positioned on one of the spool housing or a cap to the spool housing, and the control grooves is located on the spool.

9. A string trimmer comprising:
an electric motor;
a rotatable output member driven by the electric motor;
a handle coupled to the electric motor;
a spool assembly that is adapted to hold a trimming line such that the trimming line has one or more line segments that extend from the spool assembly, the spool assembly having a spool housing, a cap, a spool and a line pay-out mechanism, the spool being driven by the output member and configured such that the trimming line is wound thereon, the line pay-out mechanism being configured to control rotation of the spool relative to the output member to pay-out the trimming line from the spool in response to a difference between a first moment and a second moment, the first moment being generated by inertia of the one or more line segments, the second moment being generated by inertia of a reference weight and opposing the first moment; and
a controller coupled to the electric motor and configured to electronically control the electric motor in a line pay-out mode that generates a third moment that opposes the first moment;
the second moment alone never being capable of initiating the line pay-out mechanism; and
the user actuating the controller to produce the third moment, the second and third moment combining to initiate the line pay-out mechanism.

10. The string trimmer of claim 9 wherein:
the handle includes a trigger to control power to the motor, and the controller comprises a switch that brakes the motor to actuate the line pay-out mechanism; and
the controller is positioned on the handle in close proximity to the trigger so that a user can control both the trigger and controller with one hand.

11. The string trimmer of claim 10, wherein the electric motor is housed in a powerhead assembly.

12. The string trimmer of claim 10, wherein the controller shorts the motor to provide the braking effect.

13. The string trimmer of claim 10, wherein the controller is a DPDT switch which urges the motor in a reverse direction to provide the braking effect.

14. The string trimmer of claim 10, wherein the switch is a momentary switch.

15. A method for operating a string trimmer comprising:
providing a string trimmer with an electric motor, an output member driven by the electric motor and a spool assembly, the spool assembly having a spool and a line pay-out mechanism, the spool having a cavity onto which a trimmer line is wound, the line pay-out mechanism being operable in a pay-out mode to permit the spool to rotate relative to the output member to pay-out trimmer line from the spool;
providing a trigger on a handle of the string trimmer to provide power to the motor;
providing a controller to effectuate a braking effect on the motor, wherein the braking effect actuates the pay-out mode;
actuating the trigger to operate the motor in a trimming mode in which the electric motor operates in a first rotational direction to drive the output member, wherein inertial forces acting on the line pay-out mechanism prevent relative movement of the spool relative to the output member so that the trimming line is not paid-out from the spool assembly; and
actuating the controller to pay out additional line, wherein the braking of the motor generates inertial forces that actuate the line pay-out mechanism extend trimmer line from the spool assembly.

16. The method of claim 15, wherein actuating the controller only momentarily brakes the motor, and the motor resumes trimming mode.
